(19) United States
(12) Patent Application Publication
(10) Pub. No.: US 2016/0315544 A1
(43) Pub. Date: Oct. 27, 2016

(54) POWER SUPPLY CIRCUIT FOR REDUCING STANDBY POWER AND CONTROL METHOD THEREOF

(71) Applicant: SAMSUNG ELECTRONICS CO., LTD., Suwon-si (KR)

(72) Inventors: Sung-yong JOO, Yongin-si (KR); Jin-hyung LEE, Anyang-si (KR); Moon-young KIM, Suwon-si (KR); Youn-seung LEE, Suwon-si (KR)

(73) Assignee: SAMSUNG ELECTRONICS CO., LTD., Suwon-si (KR)

(21) Appl. No.: 15/086,881

(22) Filed: Mar. 31, 2016

(30) Foreign Application Priority Data
Apr. 21, 2015 (KR) 10-2015-0055903

(51) Int. Cl. H02M 3/335; H02M 1/08

(52) U.S. Cl. CPC H02M 3/33523; H02M 1/08; H02M 2001/0032

(57) ABSTRACT

A power supply circuit and method for driving an electronic device that operates in a first mode or a second mode is provided. The power supply circuit includes a pulse width modulation (PWM) controller configured to convert an input voltage to an output voltage, and a driving circuit that includes a switching element whose switching state is controlled in accordance with a mode change signal corresponding to the first and second modes. The driving circuit is configured to drive the PWM controller by switching off the switching element and supplying a first voltage to the PWM controller, in response to the mode change signal indicating that the electronic device operates in the first mode. When it is indicated that the electronic device operates in the second mode, the driving circuit switches on the switching element and supplies a second voltage to the PWM controller through the switching element.

### CROSS-REFERENCE TO RELATED APPLICATIONS

This application claims priority from Korean Patent Application No. 10-2015-0055903 filed on Apr. 21, 2015, in the Korean Intellectual Property Office, the disclosure of which is incorporated herein by reference in its entirety.

### BACKGROUND

1. Field of the Invention

Methods and apparatuses consistent with exemplary embodiments of the present application relate to a power supply circuit and a control method thereof, and more particularly, to a power supply circuit for reducing a standby power and a control method thereof.

2. Description of the Related Art

A standby mode may be defined as a state in which an electronic device waits for an external wakeup signal while consuming a minimal amount of energy. For televisions and audio devices, for example, the wakeup signal may be a turn-on signal that is transferred from a remote controller to the device. For personal computers, the wakeup signal may be a keyboard or mouse input signal.

Recently, with the increasing demand for electronic products that can be accessed at any time or wake up at only a moment's notice, a standby mode has been widely applied to various electronic products. In a standby mode, such electronic devices are always in an “on” state, and thus a certain amount of energy for the operations of a microcontroller unit (MCU) and peripheral circuits is consumed.

Recently, as the number of electronic devices having such a standby mode increased in homes, there arose concern about the amount of consumed energy thereof.

Conventionally, a regulator is used to achieve a stable supply of V_{CC} voltages in a high-output active mode, and according to the existing standby power reduction technology, it is always required for switching elements in the regulator to consume a certain amount of power even in a standby mode, which may eventually add up to a significant amount of energy being consumed by the regulator.

Accordingly, there has been a need for better ways to minimize the energy being wasted by the switching elements in the standby mode.

### SUMMARY

Exemplary embodiments of the present disclosure overcome the above disadvantages and other disadvantages not described above, and provide a power supply circuit and a control method thereof, which can reduce a power that is consumed by switching elements of a regulator through switching off the switching elements in a standby mode.

According to an aspect of an exemplary embodiment, a power supply circuit for driving an electronic device that operates in a first mode or a second mode includes a pulse width modulation (PWM) controller configured to generate an output voltage, based on an input voltage, for driving the electronic device. The power supply circuit further includes and a driving circuit that includes a switching element, whose switching state is controlled in accordance with a mode change signal. The driving circuit is configured to drive the PWM controller by, in response to the mode change signal indicating that the electronic device is in the first mode, switching off the switching element and supplying a first voltage to the PWM controller. In response to the mode change signal indicating that the electronic device is in the second mode, the driving circuit is configured drive the PWM controller by switching on the switching element and supplying a second voltage to the PWM controller through the switching element.

The first mode may be a standby mode, and the second mode may be an active mode.

The driving circuit may include a secondary coil portion in which a predetermined voltage is induced by a primary coil. The secondary coil portion may have a tap that divides the secondary coil portion into two coil segments. The first voltage may be supplied from the tap of the secondary coil portion, and the second voltage may be supplied from a terminal of one of the two coil segments where the terminal is connected to the switching element.

The switching element may include a transistor, and the transistor may have a first terminal that receives the mode change signal, a second terminal that is connected to the PWM controller, and a third terminal that is connected to the terminal of one of the two coil segments of the secondary coil portion.

In the case where the electronic device operates in the first mode, the driving circuit may supply the first voltage to the PWM controller using shunt wiring that connects the tap to the PWM controller.

In the case where the electronic device operates in the second mode, the driving circuit may maintain the second voltage at a constant level by changing a switching frequency of the switching element.

According to an aspect of an exemplary embodiment, a method for controlling a power supply circuit for driving an electronic device that operates in a first mode or a second mode is provided. The method includes, in response to a mode change signal, associated with the electronic device, indicating that the electronic device is in the first mode, supplying a first voltage to a PWM controller which generates an output voltage that is used for driving the electronic device, by switching off a switching element whose switching state is controlled in accordance with a mode change signal. The method also includes, in response to the mode change signal indicating that the electronic device is in the second mode, supplying, via the switching element, a second voltage to the PWM controller by switching on the switching element.

The first mode may be a standby mode, and the second mode may be an active mode.

The first voltage may be supplied a voltage from a tap of a secondary coil portion, in which a predetermined voltage is induced by a primary coil portion. The second voltage may be supplied from a terminal of the secondary coil portion divided by the tap.

The switching element may include a transistor, and the transistor may have a first terminal that receives the mode change signal, a second terminal that is connected to the PWM controller, and a third terminal that is connected to the terminal of the secondary coil portion.

The first voltage may be supplied by using shunt wiring that connects the tap to the PWM controller.

The second voltage may be maintained at constant level by changing a switching frequency of the switching element.

Accordingly, because the standby power consumption that is caused by the switching element of the regulator in the standby mode can be prevented, the power consumption in the standby mode can be reduced.

Additional and/or other aspects and advantages of the disclosure will be set forth in part in the description which follows and, in part, will be obvious from the description, or may be learned by practice of the disclosure.

### BRIEF DESCRIPTION OF THE DRAWING FIGURES

The above and/or other aspects will be more apparent by describing certain exemplary embodiments of the present disclosure with reference to the accompanying drawings, in which:

FIG. 1 is a block diagram illustrating the configuration of a power supply circuit according to an exemplary embodiment of the present disclosure;

FIG. 2 is a diagram explaining the operation of an existing power supply circuit in a standby mode;

FIG. 3 is a diagram explaining the operation of a power supply circuit in a standby mode according to an exemplary embodiment of the present disclosure; and

FIG. 4 is a flowchart explaining a method for controlling a power supply circuit according to an exemplary embodiment of the present disclosure.

### DETAILED DESCRIPTION OF THE EXEMPLARY EMBODIMENTS

The exemplary embodiments of the present disclosure may be diversely modified. Accordingly, specific exemplary embodiments are illustrated in the drawings and are described in detail in the detailed description. However, it is to be understood that the present disclosure is not limited to a specific exemplary embodiment, but includes all modifications, equivalents, and substitutions without departing from the scope and spirit of the present disclosure. Also, well-known functions or constructions are not described in detail because they would obscure the disclosure with unnecessary detail.

The terms “first,” “second,” etc. may be used to describe diverse components, but the components are not limited by the terms. The terms are only used to distinguish one component from the others.

The terms used in the present application are only used to describe the exemplary embodiments, but are not intended to limit the scope of the disclosure. The singular expression also includes the plural meaning as long as it does not differently mean in the context. In the present application, the terms “include” and “consist of” designate the presence of features, numbers, steps, operations, components, elements, or a combination thereof that are written in the specification, but do not exclude the presence or possibility of addition of one or more other features, numbers, steps, operations, components, elements, or a combination thereof.

In the exemplary embodiment of the present disclosure, a “module” or a “unit” performs at least one function or operation, and may be implemented with hardware, software, or a combination of hardware and software. In addition, a plurality of “modules” or a plurality of “units” may be integrated into at least one module except for a “module” or a “unit” which has to be implemented with specific hardware, and may be implemented with at least one processor (not shown).

Hereinafter, exemplary embodiments of the present disclosure will be described in detail with reference to the accompanying drawings.

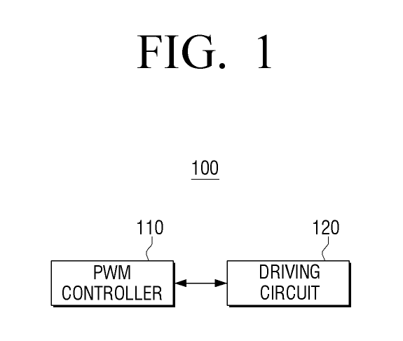

FIG. 1 is a block diagram illustrating the configuration of a power supply circuit according to an exemplary embodiment of the present disclosure.

Referring to FIG. 1, a power supply circuit 100 includes a pulse width modulation (PWM) controller 110 and a driving circuit 120.

The power supply circuit 100 functions to supply power to an electronic device. The electronic device can be, for example, a display device or a backlight light source.

The display device may be based on the organic light emitting diodes (OLED) technology. The OLED, also referred to as organic electroluminescence (EL), is a self-luminous organic material that emits light using electroluminescence phenomenon, in which, as a current flows through a fluorescent organic compound, the fluorescent organic compound emits light.

Further, the OLED has a low driving voltage, a thin profile, a wide viewing angle, and a low response time, thus making it suitable for use in displays of small devices, such as a digital camera.

As described above, because the OLED is self-luminous and does not require a separate backlight, the power supply circuit 100 may directly supply current to the OLED to allow the OLED to emit light.

On the other hand, unlike the OLED or a cathode ray tube (CRT), a liquid crystal display (LCD) is not self-luminous, and thus requires a backlight. However, the LCD has a relatively low operating voltage and low power consumption, and thus may be suitable for use in portable devices. Because the LCD is not self-luminous, it requires a backlight unit, and the power supply circuit 100 may supply power to the backlight unit.

The PWM controller 110 may receive driving voltage and driving current applied through a V_{CC} terminal, and may generate a PWM waveform having a frequency and duty cycle to control the output voltage.

Further, the PWM controller 110 may sense the output voltage and perform a feedback control for adjusting the duty cycle of the waveform generated by the PWM controller 110 to maintain constant output voltage.

The PWM controller 110 may also receive a mode change signal that indicates the operation of the electronic device has changed from a first mode to a second mode or vice versa. Subsequently, the PWM controller 100 may adjust the duty cycle of the PWM waveform in accordance with the mode change signal.

Here, the first mode may be a standby mode. The standby mode may be an output mode in which the electronic device is connected to an external power in an idle state, and none of its main functions are being performed. In standby mode, the electronic device may consume only standby power, which is typically lower than the power level during the device's operation, while the electronic device waits for an external signal, such as a turn-on signal. That is, the standby mode may mean a state where the electronic device receives no signal from the outside and does not perform an output.

On the other hand, the second mode may be an active mode. Converse to the standby mode, the active mode is an output mode in which the electronic device performs one or more main functions or receives an external signal, such as a turn-on signal for outputting an image.

Hereinafter, explanations will be made with respect to an embodiment in which the first mode is the standby mode and the second mode is the active mode.

The driving circuit 120 may include a first switching element Q1, whose switching state is controlled in accordance with the mode change signal. Here, the first switching element Q1 may be implemented with a transistor.

In the active mode, the driving circuit 120 may drive the PWM controller 110 by supplying a second voltage to the PWM controller 110 by switching on the switching element. Here, the driving circuit 120 may include a secondary coil portion in which a predetermined voltage is induced by a primary coil. The secondary coil portion may be divided by a tap in the output terminal of the electronic device, and may supply a voltage that is applied to the tap of the secondary coil portion to the PWM controller 110 in the active mode.

Further, in the active mode, the driving circuit 120 may maintain the level of the voltage that is applied to the PWM controller 110 constant by the voltage that is applied to one terminal of the secondary coil portion by changing the switching frequency of the first switching element Q1 in the active mode. In this case, the primary coil portion and the secondary coil portion may be determined by a used frequency and the level of used power.

On the other hand, in the standby mode, the driving circuit 120 may drive the PWM controller 110 by switching off the first switching element Q1 and supplying a first voltage to the PWM controller 110.

Specifically, in the standby mode, the driving circuit 120 may supply the voltage that is applied to the tap of the secondary coil portion directly to the PWM controller 110. In this case, the first switching element Q1 may have a first terminal that receives an input of the mode change signal, a second terminal that is connected to the PWM controller 110, and a third terminal that is connected to one terminal of the secondary coil portion. In the case where the first switching element Q1 is implemented by a bipolar junction transistor (BJT), the first terminal may be a base terminal, the second terminal may be an emitter terminal, and the third terminal may be a collector terminal.

Further, in the standby mode, the driving circuit 120 may apply the voltage to the PWM controller using shunt wiring that connects the tap of the secondary coil portion to the PWM controller.

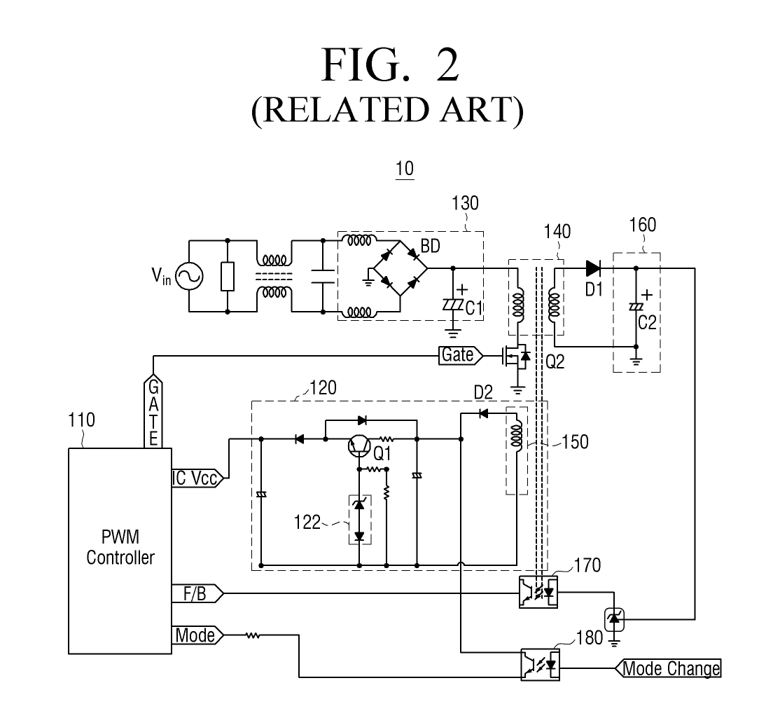

FIG. 2 is a diagram explaining the operation of an existing power supply circuit in a standby mode.

Referring to FIG. 2, a power supply circuit 10 in the related art may include a rectifier 130, a primary coil portion 140, and a PWM controller 110. The rectifier 130 may convert an alternating current (AC) power Vᵢₙ, which is input from the outside, into a direct current (DC) power. The primary coil portion 140 may transform and output the rectified DC power. The PWM controller 110 may apply a pulse signal to the primary side of the primary coil portion 140 to adjust the output voltage thereof, sense the output voltage of the primary coil portion 140 to receive the sensed output voltage as a feedback, and control the pulse signal to be applied to the primary side.

Here, the rectifier 130 may be composed of a bridge diode BD and a smoothing capacitor C1. The bridge diode BD may serve to rectify the applied AC voltage Vᵢₙ. The smoothing capacitor C1 serves to convert the AC voltage into the DC voltage having the same waveform and to apply the converted DC voltage to the primary coil of the primary coil portion 140.

The DC voltage that is rectified by the rectifier 130 is switched by a second switching element Q2, which is connected to the primary coil of the primary coil portion 140, to be converted into an AC voltage. The AC voltage that is generated on the primary coil of the transformer 140 is stepped down or boosted in the secondary coil thereof, and then is converted into a DC voltage Vₒᵤₜ by a rectifying diode D1 and a smoothing capacitor C2. Here, it is preferable that the second switching element Q2 is implemented with a field effect transistor (FET) having high voltage resistance.

On the other hand, the AC voltage that is induced from the primary coil portion 140 to a secondary coil portion 150 may be rectified by a diode D2 and applied to a V_{CC} terminal of the PWM controller 110.

The PWM controller 110 serves to supply a switching pulse to the base or gate of the second switching element Q2. The frequency of the switching pulse that is generated by the PWM controller 110 may be determined by the mode change signal and a feedback signal.

Specifically, the mode change signal, indicating a change from the standby mode to the active mode or vice versa, may be applied from a mode change signal input terminal to the PWM controller 110. Thus, the mode change signal may be a control signal that indicates which mode the electronic device is in. The mode change signal input terminal may be, for example, a terminal to which a power on/off signal of a TV or monitor is input. In this example, the mode change signal may be applied to the PWM controller 110 by a photo coupler 180. In this example, the photo coupler 180, also referred to as an opto-isolator, has a light-emitting portion which may receive the mode change signal and convert the electrical signal into light. The photo coupler 180 also has a light-receiving portion that may convert the light received from the light-emitting portion into an electrical signal and transmit to one of the terminals of the PWM controller 110. In particular, the light-emitting portion may be implemented with an LED, and the light-receiving portion may be implemented with a phototransistor.

On the other hand, in the active mode, if the charged voltage is lower than a charge start voltage, the smoothing capacitor C2 may generate a feedback signal for maintaining the charged voltage and transfer the generated feedback signal to the PWM controller 110 through a photo coupler 170. Further, in the standby mode, if the charged voltage is lower than a predetermined voltage, the smoothing capacitor C2 may generate a feedback signal for maintaining the standby mode and transfer the generated feedback signal to the PWM controller 110 through the photo coupler 170.

The driving circuit 120 may also include a Zener diode 122 that is connected to the base or gate of the first switching element Q1. The driving circuit 120 may adjust the switching frequency of the switching element Q1 by using the Zener diode 122, and thus even if a voltage that is higher than the predetermined voltage is applied to the collector of the transistor, the predetermined voltage can be uniformly applied to the V_{CC} terminal of the PWM controller 110.

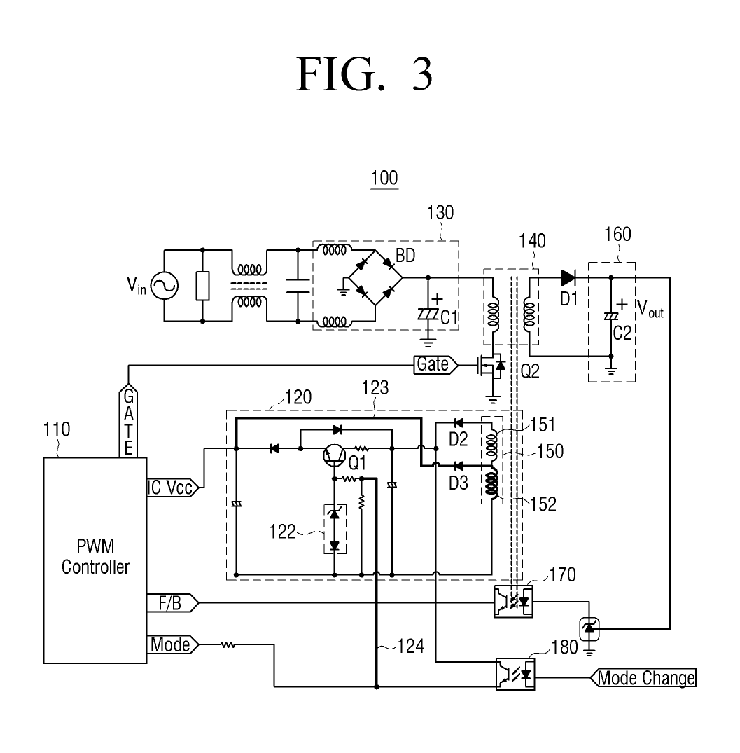

FIG. 3 is a diagram explaining the operation of a power supply circuit in a standby mode according to an exemplary embodiment of the present disclosure. Descriptions regarding those elements of the power supply circuit 10 of FIG. 2 that overlap with the elements of the power supply circuit 100 of FIG. 3 may also apply to the power supply circuit 100 of FIG. 3.

As illustrated in FIG. 3, the driving circuit 120 of the power supply circuit 100 may include a new electrical connection that is separate from the electrical connection through which the first switching element Q1 is turned on to supply the voltage that is applied to a tap of a secondary coil portion 150 to the PWM controller 110. The tap may logically divide the secondary coil portion 150 into a first coil 151 and a second coil 152.

Specifically, the driving circuit 120 may further include shunt wiring 123 that has one end connected to the tap of the secondary coil portion 150 and the other end connected to the V_{CC} terminal of the PWM controller 110. The shunt wiring may further include a diode D3 that can rectify the AC voltage that is induced from the primary coil portion 140.

Further, the driving circuit 120 may further include a new line 124 connected between the photo coupler 180, to which the mode change signal is input, and the base of the first switching element Q1. In the case where the electronic device operates in the standby mode, a low-level mode change signal may be input to the base of the first switching element Q1, and in the case where the electronic device operates in the active mode, a high-level mode change signal may be input thereto.

That is, the driving circuit 120 may interlock with the mode change signal input terminal that is connected through the photo coupler 180, and the first switching element Q1 may switch on to drive the driving circuit 120 only when the high-level mode change signal is input to the base of the first switching element Q1.

For example, even in the case where the voltage that is applied to the first coil 151 of the secondary coil portion 150 is higher than the voltage that is applied to the second coil 152 thereof, the driving circuit 120 that interlocks with the mode change signal input terminal may switch off the first switching element Q1 in accordance with the standby mode signal, and thus the voltage that is applied to the first coil 151 may not be applied to the V_{CC} terminal of the PWM controller 110 through the first switching element Q1.

That is, in the standby mode, the first switching element Q1 may be switched off and open, thus causing the voltage that is applied to the second coil 152 of the secondary coil portion 150 to be applied to the V_{CC} terminal of the PWM controller 110 through the shunt wiring 123.

Further, in the active mode, the switch of the transistor Q1 is switched on to be turned on, and thus the voltage that is applied to the first coil 151 of the secondary coil portion 150 is applied to the V_{CC} terminal of the PWM controller 110 through the first switching element Q1.

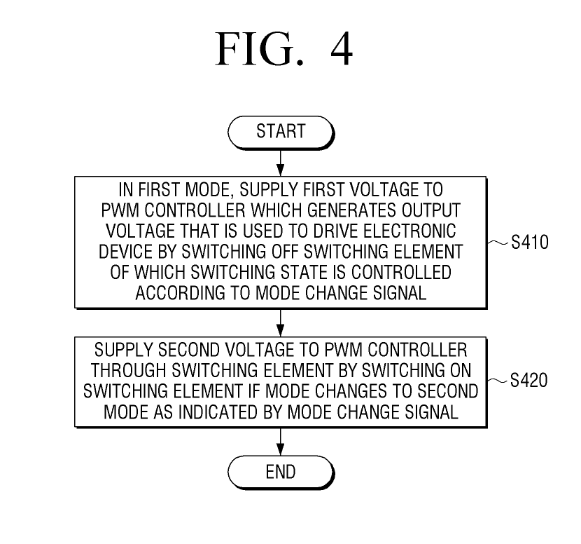

FIG. 4 is a flowchart explaining a method for controlling a power supply circuit according to an exemplary embodiment of the present disclosure.

First, in a first mode, a first voltage is supplied to a PWM controller that generates an output voltage that is used to drive the electronic device by switching off a switching element of which a switching state is controlled in accordance with a mode change signal (S410). Here, the first mode may be a standby mode, and a second mode may be an active mode. A voltage that is applied from a primary coil portion, in which a predetermined voltage is induced to a tap of a secondary coil portion, may be supplied to the PWM controller, and at this time, shunt wiring may be used to connect the tap to the V_{CC} terminal of the PWM controller.

Thereafter, if the mode changes from the first mode to the second mode as indicated by the mode change signal, the switching element is switched on, and a second voltage may be supplied to the PWM controller through the switching element (S420). In this case, the voltage that is applied to one terminal of the secondary coil portion that is connected to the switching element may be supplied to the PWM controller. The switching element can maintain the level of the voltage that is applied to the PWM controller constant by the voltage that is applied to the one terminal of the secondary coil portion through changing a switching frequency of the switching element.

The switching element may be implemented with a transistor, and the transistor may have a first terminal for receiving an input of the mode change signal, a second terminal connected to the PWM controller, and a third terminal connected to one end of the secondary coil portion.

As described above, the power supply circuit according to various embodiments of the present disclosure can considerably reduce the standby power consumption because the switching element of the regulator does not consume any power in the standby mode.

The foregoing exemplary embodiments and advantages are merely exemplary and are not to be construed as limiting the present disclosure. The present teaching can be readily applied to other types of apparatuses. Also, the description of the exemplary embodiments of the present disclosure is intended to be illustrative, and not to limit the scope of the claims, and many alternatives, modifications, and variations will be apparent to those skilled in the art.

What is claimed is:

1. A power supply circuit for driving an electronic device that operates in one of a first mode and a second mode, the power supply circuit comprising:
a pulse width modulation (PWM) controller configured to convert an input voltage to an output voltage that drives the electronic device; and
a driving circuit comprising a switching element whose switching state is controlled in accordance with a mode change signal corresponding to at least one of the first mode and the second mode, the driving circuit being configured to drive the PWM controller by:
in response to the mode change signal indicating that the electronic device operates in the first mode, switching off the switching element to supply a first voltage to the PWM controller, and
in response to the mode change signal indicating that the electronic device operates in the second mode, switching on the switching element to supply a second voltage to the PWM controller through the switching element.

2. The power supply circuit as claimed in claim 1, wherein the first mode is a standby mode in which the electronic device idles according to the first voltage, and the second mode is an active mode in which the electronic device operates according to the second voltage, the second voltage being higher than the first voltage.

3. The power supply circuit as claimed in claim 1, wherein the driving circuit further comprises:
a primary coil portion; and
a secondary coil portion in which a predetermined voltage is induced by the primary coil portion, the secondary coil portion comprising a tap dividing the secondary coil portion into two coil segments, and
wherein the first voltage is supplied from the tap of the secondary coil portion, and the second voltage is supplied from a terminal of one of the two coil segments, the terminal being connected to the switching element.

4. The power supply circuit as claimed in claim 3, wherein the switching element comprises a transistor, and
the transistor comprises a first terminal that receives the mode change signal, a second terminal that is connected to the PWM controller, and a third terminal that is connected to the terminal of the one of the two coil segments.

5. The power supply circuit as claimed in claim 3, wherein the driving circuit further comprises shunt wiring that connects the tap to the PWM controller, and the shunt wiring supplies the first voltage to the PWM controller.

6. The power supply circuit as claimed in claim 3, wherein the driving circuit is further configured to, in response to the mode change signal indicating that the electronic device operates in the second mode, maintain the second voltage at a constant level by controlling a switching frequency of the switching element.

7. A method for controlling a power supply circuit for driving an electronic device that operates in one of a first mode and a second mode, the method comprising:
in response to receiving a mode change signal, associated with the electronic device, indicating that the electronic device operates in the first mode, supplying a first voltage to a pulse width modulation (PWM) controller configured to generate an output voltage that drives the electronic device, by switching off a switching element whose switching state is controlled in accordance with the mode change signal; and
in response to the mode change signal indicating that the electronic device operates in the second mode, supplying, via the switching element, a second voltage to the PWM controller by switching on the switching element.

8. The method as claimed in claim 7, wherein the first mode is a standby mode in which the electronic device idles according to the first voltage, and the second mode is an active mode in which the electronic device operates according to the second voltage, the second voltage being higher than the first voltage.

9. The method as claimed in claim 7, wherein a primary coil portion induces a predetermined voltage in a secondary coil portion which is divided by a tap, and the first voltage is supplied from the tap of the secondary coil portion, and wherein the second voltage is supplied from a terminal of the secondary coil portion.

10. The method as claimed in claim 9, wherein the switching element comprises a transistor, and
the transistor comprises a first terminal that receives the mode change signal, a second terminal that is connected to the PWM controller, and a third terminal that is connected to the terminal of the secondary coil portion.

11. The method as claimed in claim 9, wherein the first voltage is supplied via shunt wiring that connects the tap to the PWM controller.

12. The method as claimed in claim 9, wherein the second voltage is maintained at a constant level by changing a switching frequency of the switching element.

13. A power supply circuit comprising:
a mode change signal input terminal configured to receive a control signal indicating a mode of an electronic device, the mode being one of a first mode and a second mode;
a modulation controller configured to control an output voltage that drives the electronic device; and
a driving circuit configured to:
receive the control signal from the mode change signal input terminal,
in response to the control signal indicating that the electronic device operates in the first mode, supplying a first driving voltage to the modulation controller to generate a first output voltage, and
in response to the control signal indicating that the electronic device operates in the second mode, supplying a second driving voltage to the modulation controller to generate a second output voltage higher than the first output voltage.

14. The power supply circuit as claimed in claim 13, wherein the first mode is a standby mode in which the electronic device idles according to the first voltage, and the second mode is an active mode in which the electronic device operates according to the second voltage, the second voltage being higher than the first voltage.

15. The power supply circuit as claimed in claim 13, wherein the modulation controller is a PWM controller configured to control the output voltage by generating, based on a driving voltage, a waveform having a frequency and a duty cycle.

16. The power supply circuit as claimed in claim 13, wherein the driving circuit comprises a switching element configured to control a driving voltage for the modulation controller.

17. The power supply circuit as claimed in claim 16, wherein the mode change signal input terminal is connected to the switching element, and a switching operation of the switching element is controlled based on the control signal.

18. The power supply circuit as claimed in claim 13, wherein the modulation controller is further configured to:
receive the control signal from the mode change signal input terminal, and
generate a switching pulse for controlling a switching element, the switching pulse having a frequency determined by the control signal.

19. The power supply circuit as claimed in claim 13, wherein the driving circuit comprises a secondary coil portion divided by a tap.

20. The power supply circuit as claimed in claim 19, wherein the first driving voltage is supplied from the tap, and the second driving voltage is supplied from a terminal of the secondary coil portion.
